(19) United States
(12) Patent Application Publication
(10) Pub. No.: US 2007/0104187 A1
(43) Pub. Date: May 10, 2007

(54) Cache-based free address pool

(75) Inventors: Vamsi M. Tatapudi, Santa Clara, CA (US); Chien-Hsien Wu, Cupertino, CA (US); Yuan Lu, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/593,103

(22) Filed: Nov. 6, 2006

Related U.S. Application Data
(60) Provisional application No. 60/735,215, filed on Nov. 10, 2005.

(51) Int. Cl. G06F 9/34; H04L 12/50; H04Q 11/00; H04L 12/56

(52) U.S. Cl. 370/368; 370/371; 370/374; 370/378; 370/381; 370/412; 711/200

(57) ABSTRACT

A method and apparatus for managing memory according to several embodiments of the invention. According to embodiments, the invention includes providing a memory including a plurality of memory locations configured to store data, providing a memory address pool having a plurality of available memory addresses and providing a cell free address pool (CFAP), including a memory address pointer, wherein the memory address pointer indicates a next available memory address in the memory address pool.

### CROSS-REFERENCE TO RELATED APPLICATIONS

This application claims priority of U.S. Provisional Patent Application Ser. No. 60/735,215 filed on Nov. 10, 2005. The subject matter of this earlier filed application is hereby incorporated by reference.

### BACKGROUND OF THE INVENTION

1. Field of the Invention

The invention relates to a method and apparatus for high performance switching in local area communications networks. In particular, the invention relates to a buffer management and flow control mechanism that utilizes priority groups in the handling of packets in the network device, so that flows of data and types of data can be managed in ways that allow for all resources to be efficiently utilized.

2. Description of the Related Art

A switching system may include one or more network devices, such as an Ethernet switching chip, each of which includes several modules that are used to process information that is transmitted through the device. Specifically, the device may include at least one ingress module, a Memory Management Unit (MMU) and at least one egress module. The ingress module may include switching functionality for determining to which destination port a packet should be directed. The MMU is used for storing packet information and performing resource checks. The egress module may be used for performing packet modification and for transmitting the packet to at least one appropriate destination port. One of the ports on the device may be a CPU port that enables the device to send and receive information to and from external switching/routing control entities or CPUs. Some devices also include a CPU processing module through which the device interfaces with external CPU ports.

In the processing of datagrams, such as packets, certain packets may receive preferential treatment when compared to other packets. As such, certain packets may be assigned a higher Quality of Service (QoS), such that those packets are given preferred treatment. This preferred treatment may be given, for example, to packets where time sensitive receipt of those packets is important. In many prior art systems, many QoS states are assigned, so that varying degrees of handling and prioritization can be provided. However, even if a small amount of bandwidth is allocated to a particular QoS state and is not used, that bandwidth is “wasted,” in that it could be utilized by other resources. Thus, there is a need in the prior art for systems that allow for dynamic management of buffers and thresholds to allow for efficient utilization of all resources of a network device.

### BRIEF DESCRIPTION OF THE DRAWINGS

For the present invention to be easily understood and readily practiced, various embodiments will now be described, for purposes of illustration and not limitation, in conjunction with the following figures:

FIG. 1 is an illustration of a network device in which an embodiment of the present invention may be implemented;

FIG. 2 illustrates a centralized egress pipeline architecture of an egress stage in an exemplary embodiment of the present invention;

FIG. 3 illustrates multiple pipelines for controlling flows of data from the ports to and from the MMU in an exemplary embodiment of the present invention;

FIG. 4 illustrates an MMU data path in an exemplary embodiment of the present invention;

FIG. 5 illustrates a logical view of the CBP;

FIGS. 6A-6G illustrates examples of how the CFAP stack grows and shrinks;

FIG. 7 illustrates an exemplary block diagram of implementation details of the CFAP; and

FIG. 8 illustrates the state machine of the CFAP.

### DETAILED DESCRIPTION OF THE PREFERRED EMBODIMENTS

The present invention is directed to many embodiments that provide many useful features with respect to memory management.

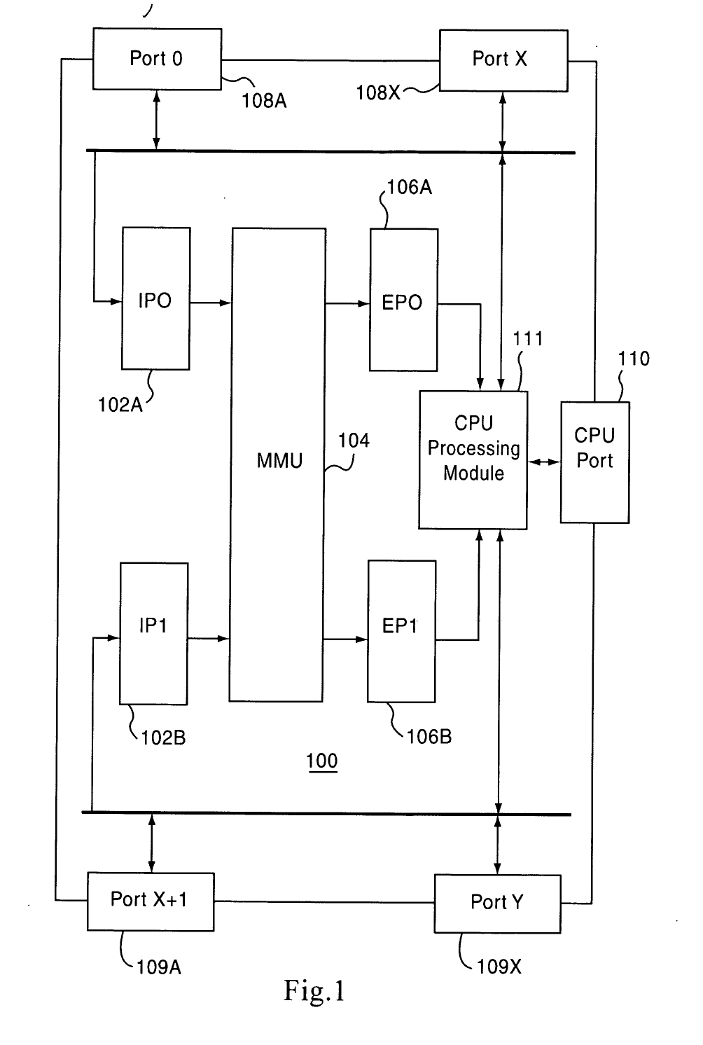

FIG. 1 illustrates a network device, such as a switching chip, in which an embodiment the present invention may be implemented. Device 100 includes ingress modules 102A and 102B, a MMU 104, and egress modules 106A and 106B. Ingress modules 102A and 102B are used for performing switching functionality on an incoming packet. MMU 104 is used for storing packets and performing resource checks on each packet. Egress modules 106A and 106B are used for performing packet modification and transmitting the packet to an appropriate destination port. Each of Ingress modules 102A, 102B, MMU 104 and Egress modules 106A and 106B include multiple cycles for processing instructions generated by that module. Device 100 implements a dual-pipelined approach to process incoming packets. One aspect which effects the performance of device 100 is the ability of the pipelines to process one packet every clock cycle. It is noted that the embodiment illustrated in FIG. 1 shows dual-pipelines, the present invention may also be applicable to systems that use a single pipeline or more than two pipelines.

Device 100 can also include a number of ports to send and receive data, such as Port 0 to PortX, 108A-108X, and Port X+1 to Port Y, 109A-109X. The ports can be separated and are serviced by different ingress and egress port modules to support the dual-pipeline structure. One or more internal fabric high speed ports, for example a high-speed port, or more external Ethernet ports may be configured from the above-discussed ports. The network device can also include a CPU port 110 and a CPU processing module 11 to communicate with an external CPU. High speed ports are used to interconnect various network devices in a system and thus form an internal switching fabric for transporting packets between external source ports and one or more external destination ports. As such, high speed ports are not externally visible outside of a system that includes multiple interconnected network devices. CPU port 110 can be used to send and receive packets to and from external switching/routing control entities or CPUs. Device 100 interfaces with external/off-chip CPUs through a CPU processing module 111, which interfaces with a PCI bus that connects device 100 to an external CPU.

Network traffic also enters and exits device 100 through external ports 108A-108X and 109A-109X. Specifically, traffic in device 100 is routed from an external source port to one or more unique destination ports. In one embodiment of the invention, device 100 supports physical Ethernet ports and logical (trunk) ports. A physical Ethernet port is a physical port on device 100 that is globally identified by a global port identifier. In an embodiment, the global port identifier includes a module identifier and a local port number that uniquely identifies device 100 and a specific physical port. The trunk ports are a set of physical external Ethernet ports that act as a single link layer port. Each trunk port is assigned a global trunk group identifier (TGID). According to an embodiment, device 100 can support up to 128 trunk ports, with up to 8 members per trunk port, and up to 29 external physical ports.

Once a packet enters device 100 on a source port 109A-109X or 108A-108X, the packet is transmitted to one of the ingress modules 102A or 102B for processing. Packets may enter device 100 from a XBOD or a GBOD. The XBOD is a block that has one 10GE/12G MAC and supports packets from high speed ports and the GBOD is a block that has 12 10/100/1G MAC and supports packets from other ports.

The architecture of the network device provides for the ability to process data received quickly and also allows for a flexibility of processing. A part of this flexibility comes from the pipeline structure that is used to process packets once they are received. Data from the packet and attributes of that packet move through the modules of the network device, discussed above, in a pipeline structure. Each stage in the pipeline structure requires a set number of clock cycles and the packets are processed in order. Therefore, the packet is parsed, table lookups are performed, a decision routing process is performed and the packet is modified, before being sent out on an egress port. Each stage in the pipeline performs its function so that the overall function of the network device is achieved.

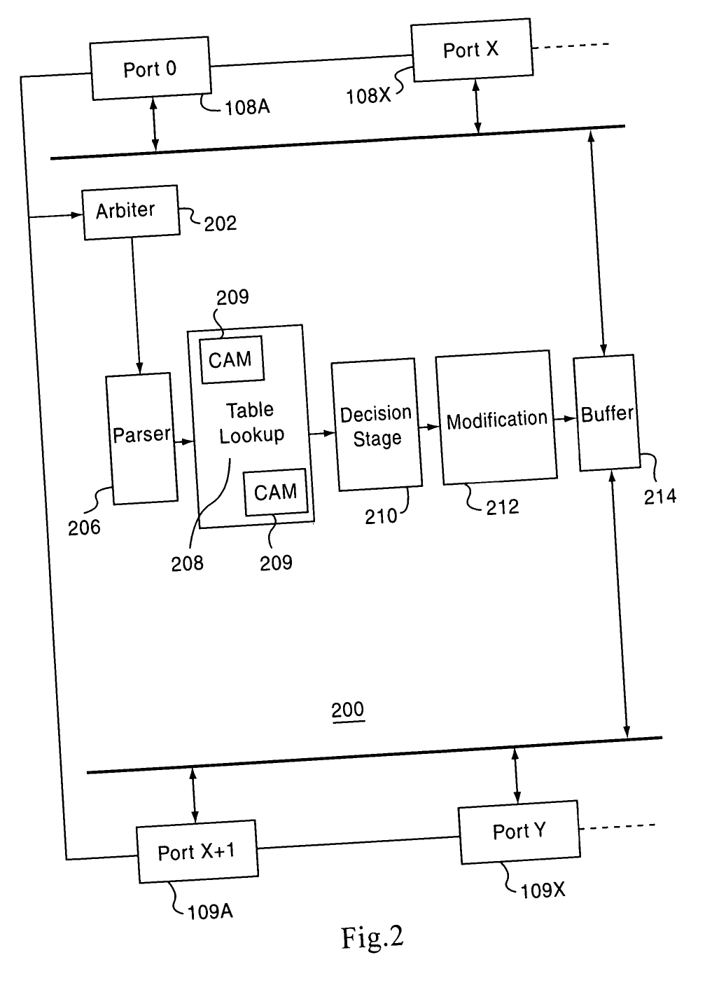

FIG. 2 illustrates a centralized egress pipeline architecture 200 of egress stages 106A and 106B, i.e. one side of the dual-pipeline. The egress pipeline can include an arbiter 202, a parser 206, a table lookup stage 208, multiple content-addressable memories (CAMs) 209, a decision stage 210, a modification stage 212 and a data buffer 214. Arbiter 202 provides arbitration for accessing egress pipeline 200 resources between packet data and control information from MMU and information from the CPU. Parser 206 performs packet parsing for table lookups and modifications. Table lookup stage 208 performs table lookups for information transmitted from parser 206, through use of the CAMs 209. The decision stage 210 is used for deciding whether to modify, drop or otherwise process the packet. The modification stage 212 makes modifications to the packet data based on outputs from previous stages of the ingress module.

Arbiter 202 collects packet data and control information from MMU 104 and read/write requests to registers and memories from the CPU and synchronizes the packet data and control information from MMU 104 and writes the requests from the CPU in a holding register. Based on the request type from the CPU, arbiter 202 generates pipeline register and memory access instructions and hardware table initialization instructions. After arbiter 202 collects packet data, CPU requests and hardware table initialization messages, it generates an appropriate instruction. According to an embodiment, arbiter 202 generates a Start Cell Packet instruction, an End Cell of Packet instruction, a Middle Cell of Packet instruction, a Start-End Cell of Packet instruction, a Register Read Operation instruction, a Register Write Operation instruction, a Memory Read Operation instruction, a Memory Write Operation instruction, a Memory Reset Write Operation instruction, a Memory Reset Write All Operation instruction and a No Operation instruction. Egress pipeline resources associated Start Cell Packet instructions and Start-End Cell of Packet instructions are given the highest priority by arbiter 204. End Cell of Packet instructions, Middle Cell of Packet instructions, Register Read Operation instructions, Register Write Operation instructions, Memory Read Operation instructions and Memory Write Operation instruction receive the second highest priority from arbiter 204. Memory Reset Write Operation instructions and Memory Reset Write All Operation instructions receive the third highest priority from arbiter 204. No Operation instructions receive the lowest priority from arbiter 204.

After receiving an instruction from arbiter 204, the parser 206 parses packet data associated with the Start Cell of Packet instruction and the Start-End Cell of Packet instruction using the control information and a configuration register transmitted from arbiter 206. According to an embodiment, the packet data is parsed to obtained L4 and L3 fields which appear in the first 148 bytes of the packet. Table lookup stage 208 then receives all packet fields and register values from parser 206.

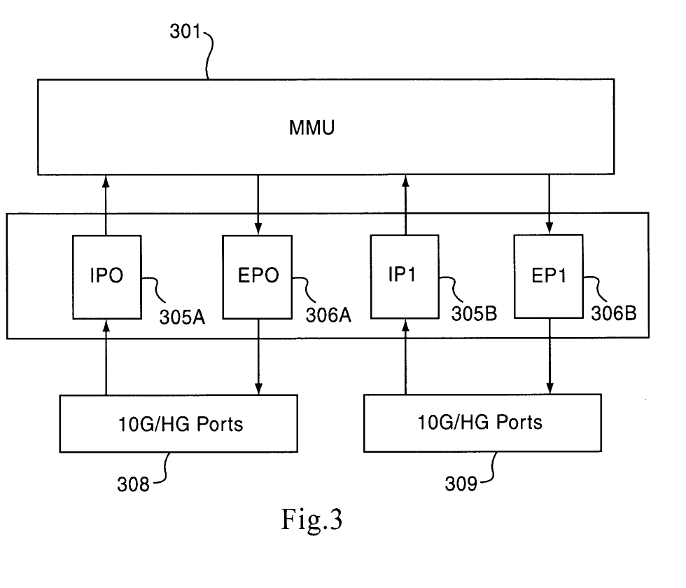

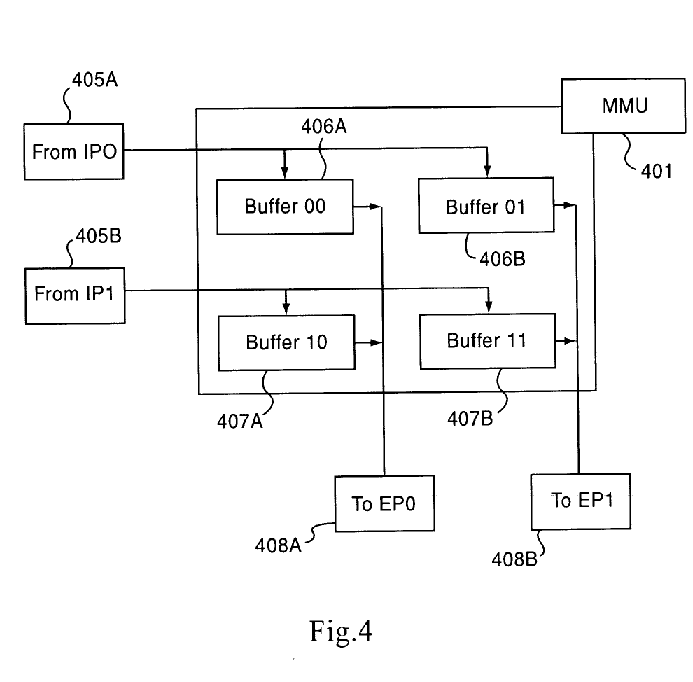

As discussed above, the network device can, according to certain embodiments, use two sets of IP/EP pipelines to support 20 ports of 10GE (or 16 ports of 12G high-speed) as shown in FIG. 3. Thus, in the illustrated embodiment, ports 0-9 308 are served by IP0 305A and EP0 306A, and ports 10-19 309 are served by IP1 305B and EP1 306B. Both sets of modules communicate with a single MMU 301. To support 20 ports of 10GE, the MMU 401 is split into 4 crosspoint buffers, as illustrated in FIG. 4. Thus, data coming from IP0 405A is received by buffers 00 and 01 (406A & 406B) before being sent to EP0 and EP1 (408A & 408B), with buffers 10 and 11 (707A & 407B) receiving data from IP1 405B. It should be noted that the multiple buffers can be reduced to a single shared buffer by speeding up the memory. Each buffer handles 10 input ports and 10 output ports, making the bandwidth requirement for each memory unit 100 Gbps, bi-directional, according to certain embodiments.

The Admission control (ADM), including thresholds, and enqueueing occur at each cross-point buffer and are independent of the other crosspoint buffers. Therefore, separate cell buffer counts and queues are provided at each crosspoint. This means that each output port will own two physical queues for each logical queue implemented. The two physical queues have packets that are of the same class to the same output port, but from different sets of input ports. The output port and queue scheduling should to be done on a unified basis for each port. Each port scheduler should see the physical queues at each of two crosspoint buffers, but only needs a scheduling database (min/max values) on a per logical queue basis. One difference from prior art network devices is the addition of 2 extra queues at each high-speed output port, named the SC and QM queues. The CONTROL opcode can be used to map packets in the SC queue when in a specific mode. Legacy packets that are E2EFC or E2ECC packets (as determined by the DMAC address) will be mapped into the QM queue of the egress high-speed port when in the specific mode.

The MMU uses the XQ queuing structure with 2 k XQ's per port (29 ports), in one embodiment. The XQ's are very different for the GE, HG (i.e. high-speed port), and CPU ports. Much of the header information that is required to format outgoing packets on the HG ports is held in the HG's XQ. This is because the network device may have 4 HG ports with 2 k XQ entries each, or a total of 8 k HG XQ's, and there are 12 k cells. With all ports potentially HG ports, according to one embodiment, much of the data in the HG XQ's is moved the Packet Header table (indexed by cell address). The functional part of the XQ is broken up into two separate memories: pktLink and pktHDR. Most of the packet information is not contained in the pktHDR which is shared by all ports and queues. The pktLink is used to link one packet to the next to form a linked-list queue. The only portion that is not shared between ports is the pktLink table, so that multicast packets can be linked anywhere in the queue for different ports. This allows all CoS queues within a port to share all of the pktLink entries for that port. Also, the pktLink size is changed to be 4 k per port (the same as the number of cells). With a complete set of packet links (4 k) per port, more of the memory can be flexibly used, enabling maximum utilization with the dynamic threshold scheme. This obviates the need for thresholds on a packet basis. All thresholds are only based on cell counters per queue and per port. Also, there is no need for a first_cell pointer in the XQ entry since the address of the pktLink entry is the same as the first_cell address.

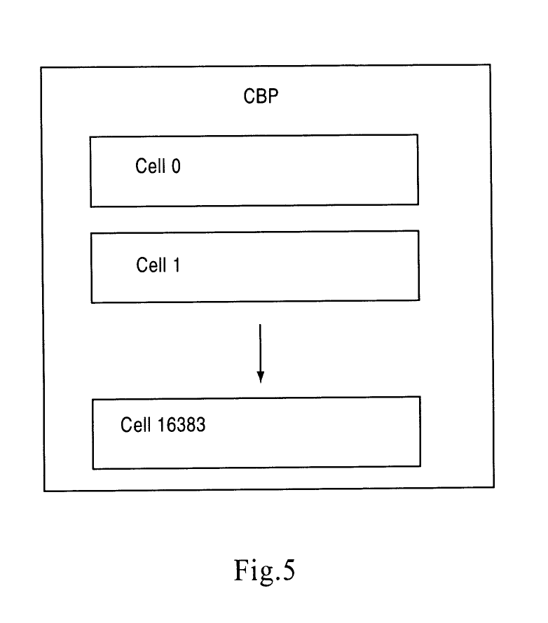

FIG. 5 illustrates a logical view of the central buffer pool (CBP). The MMU 104 is organized as several smaller physical memory units. According to an exemplary embodiment of the invention, the MMU 104 receives and sends data in 128 byte data portions or “cells.” Since in this example each cell is 128B, and the total buffer space is 2 MB. Thus, the CBP can be thought of as an array with 12K-16K elements (1.5 MB-2.0 MB/128B). Each element of the array points to a 128B sized buffer in the CBP.

However, when deciding how to allocate the 12K-16K CBP to the incoming and outgoing data traffic, several factors need to be considered. For example, cells can come into the MMU interleaved from different ports and can go out interleaved to different ports. Further, some ports may require many cells, while other ports may require very few, if any, cells. Still further, because cells come in at a very fast rate, they have to be allocated immediately. Therefore, it is not practical to run an elaborate search algorithm in order to determine which memory slots are available because of the limited amount of time available to allocate memory locations.

According to an exemplary embodiment, the CFAP 105 is implemented as an array of free cell pointers in order to determine the available memory slots in an effective manner. Each entry of the CFAP array has a pointer to a free, or unused, memory cell in CBP memory.

According to an exemplary embodiment of the invention, the CFAP has pointers to 12K-16K locations in the CBP. As the memory cells are used, they are removed from the CBP. As the memory cells are emptied or freed up, they are added back to the CBP.

The CFAP, with for example 12K-16K locations, is initialized or reset such that in location 0 of the CFAP points to CBF cell 0, location 1 of the CFAP points to CBF cell 1 and so on. However, in the present invention, the pointers are established, either by software or from memory, such that upon initialization, the pointers can be set up in any predetermined order.

The CFAP 105 uses memory to store all of the free address pointers. In an embodiment of the present invention, the CFAP 105 implements a stack algorithm to manage the memory. Thus, as cells come in they are logically “pushed” onto the stack. As cells become available they are logically “popped” from the stack.

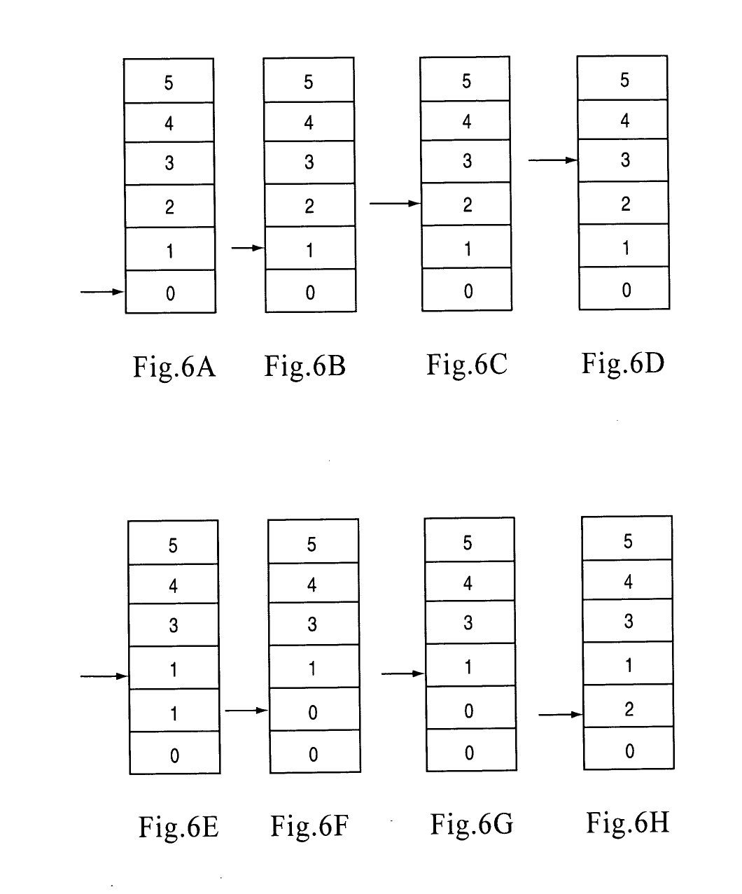

FIGS. 6A-6H illustrate an example of how the CFAP stack can grow and shrink based on cell traffic. As shown in FIG. 6A, at initialization the pointer points to cell location 0 to indicate that the first available cell location on the CBP is location 0. As a cell comes in it is placed in location 0 of the CBP. Thus, the CFAP needs to indicate the next available location of the CBP.

As shown in FIG. 6B the CFAP indicates that the next available cell location in the CBP is cell 1, by pointing to CFAP location 1. In FIG. 6C, cell 1 is allocated. Thus, the CFAP indicates that the next available cell location is location 2. Similarly, in FIG. 6D, cell 2 is allocated. Thus, the CFAP indicates that the next available cell location is location 3.

FIG. 6E illustrates the scenario when cell location 1 is returned to the CBP. When cell location 1 is returned it is pushed onto the stack in the location of original cell location 2, thus the CFAP indicates that the stack has “shrunk.” Thus, the next available cell location is the cell location that was originally identified as cell location 2 in FIG. 6A. Similarly, as shown in FIG. 6F, when cell location 0 is returned, the stack grows. As shown in FIG. 6F the next available cell location is the cell location that was originally identified as cell location 1, but is now identified as cell location 0 since cell location 0 was pushed onto the stack once cell location 0 was returned.

FIG. 6G shows the scenario when subsequently, the new cell location 0 is allocated, thus new cell location 1 is the next available cell location. Then, as shown in FIG. 6H when cell 2 is returned it is pushed onto the stack.

According to another exemplary embodiment of the invention, the CFAP is implemented as a queue. When the CFAP is implemented as a queue, the cell locations are placed in a queue. As cells are allocated, the allocated location is dequeued and made unavailable. As cells are returned the available cell location is enqueued.

As illustrated in FIG. 2, the device 100 may include two ingress pipelines and two egress pipelines. Therefore, two memory cell locations need to be accessed (read or write) per one clock cycle. In accordance with an embodiment of the present invention, this is accomplished by use of a single port memory instead of dual port memory. The single port memory eliminates the need for a memory wrapper typically needed for dual port memory and therefore reduces overall space.

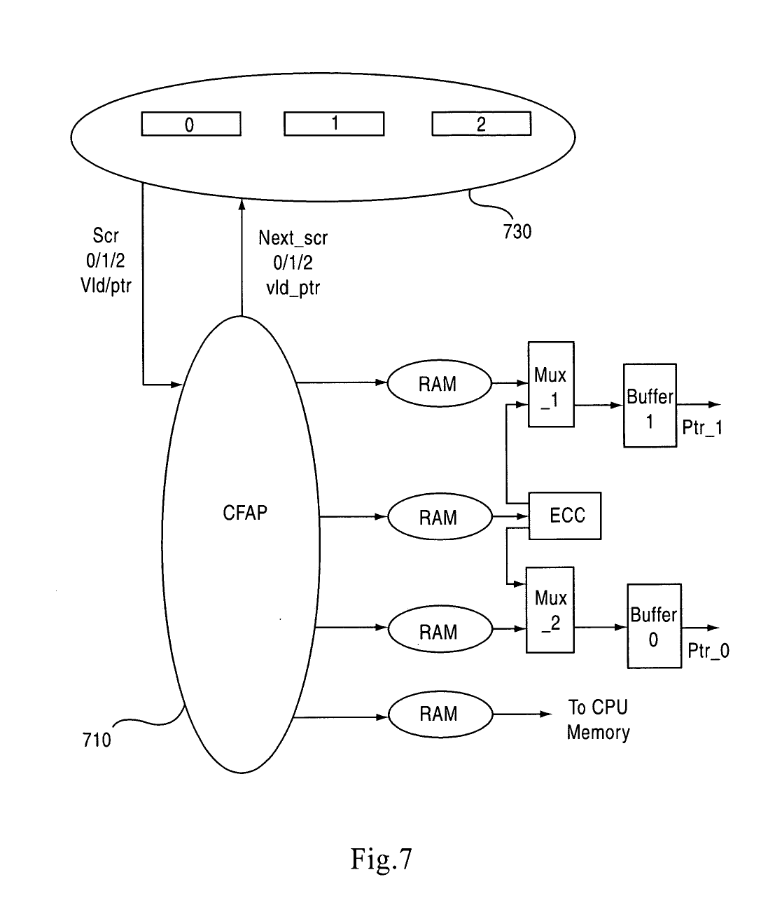

FIG. 7 illustrates an exemplary configuration of the CFAP.

Accordingly to the exemplary embodiment of the invention the CFAP is implemented with error correction code protection (ECC) for the CFAP memory. The CFAP 710 according to an exemplary embodiment of the invention has 6K locations. Thus, error correction is provided by 6K×7=42K bits. This is a reduction in the number of bits required per entry that is required in the prior art.

According to this exemplary embodiment of the invention the CFAP 710 has one memory with 6144 memory entries and the width of each entry is 34 bits. Further, 6 bit error code correction is used, and each entry of the CFAP memory has two CBP addresses. Because of the two CBP addresses, the ECC bits are shared between the two pointers. Thus, instead of 12K×5=60K bits being used 6K×6=36K bits are used, saving 24K bits.

The CFAP further includes a cell address cache 730 according to an embodiment of the present invention. The cache memory is used as a “scratch pad” to hold excess cell locations. The cache can have from 1-12K entries. The higher the number, the higher the design complexity, but it helps lower the “miss rate” of the access. According to a preferred exemplary embodiment of the invention, a scratch pad size of three is utilized.

The device 100 pre-allocates cell locations to incoming packets as opposed to receiving the packets and determining available cell locations to place the packets. For example, two cell locations may be pre-allocated for the packet but for only one cell location is needed. Thus, instead of immediately returning the unused cell location to the pool to be recycled, the unused cell location is indicated in the “scratch pad.” Therefore, in the event that in the next clock cycle, two cell locations are pre-allocated, but only one of which are currently available, the previously unused cell location that was placed on the scratch pad, is not used.

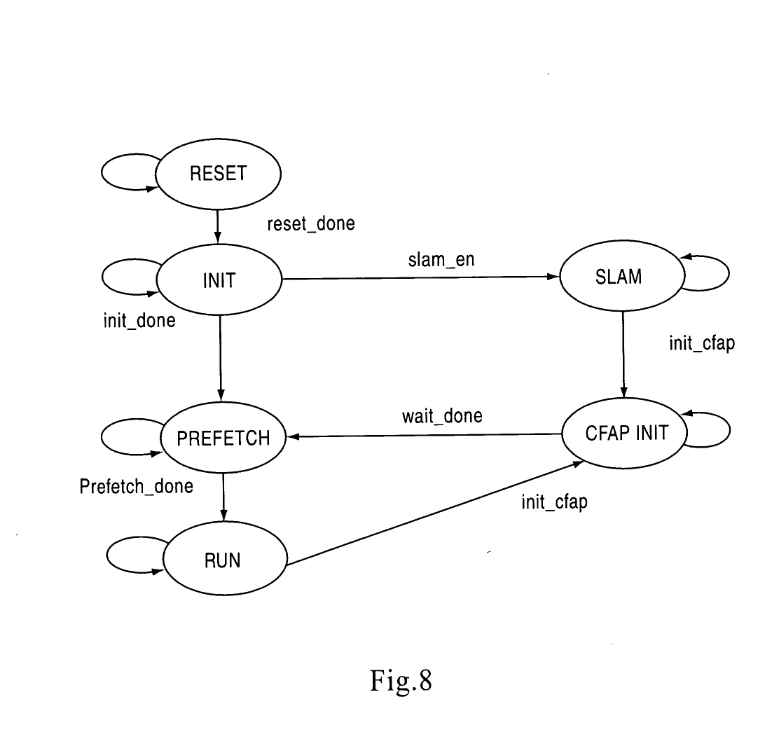

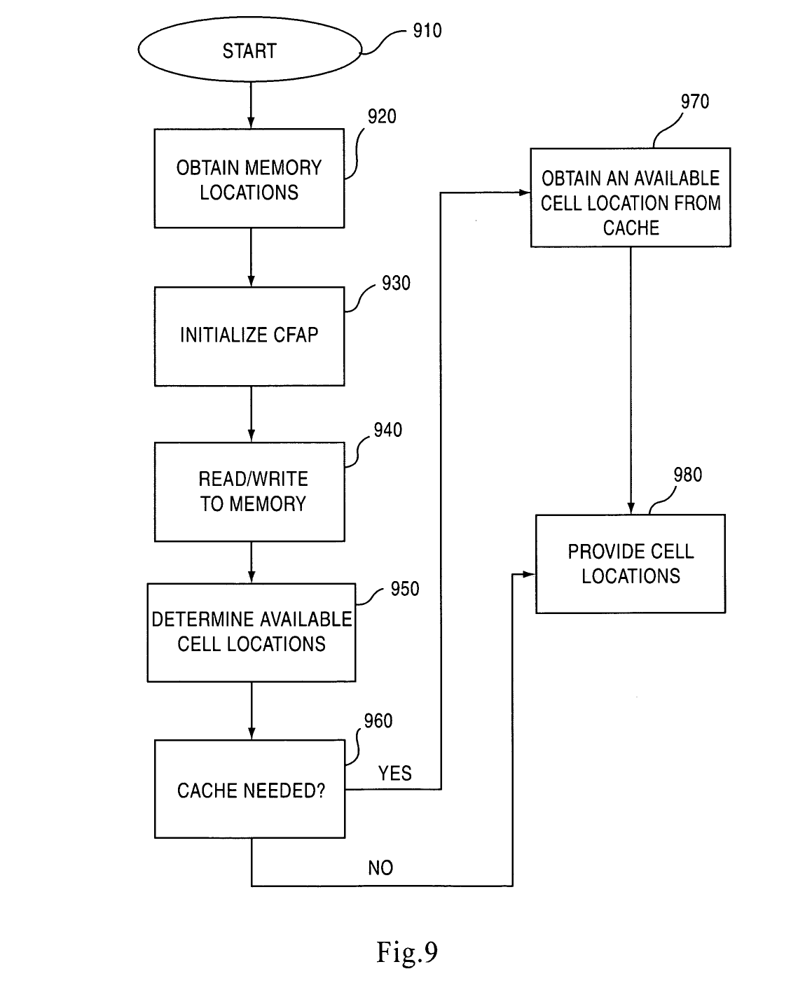

FIG. 8 illustrates a state machine for the CFAP. After RESET system initialization is performed at INIT. Once INIT is completed, the system enters the PREFETCH state where pointers are pre-fetched for usage before traffic starts. Once PREFETCH is complete, the system enters RUN state, where the CFAP is ready to service traffic. According to this embodiment, the CFAPINIT state can be entered by programming the init_cfap register bit. This allows the user to reinitialize the CFAP as needed and to restart the PREFETCH-RUN cycle. Thus, any defective pointers can be removed from the CFAP stack.

According to an exemplary embodiment of the invention the CFAP is implemented with interface signals that include but are not limited to the following. The clk and rst_1 are input signals to the CFAP. The clk signal is the core clock, operating at 180 MHz. The rst_1 is the core reset signal that is synchronized with the core clock clk.

The CFAP is further implemented with interface signals regarding the parity, slam and error. The parity_check_en signal is an input signal that enables parity/ecc generation for writes, and parity/ecc checking for reads. The parity_error is an output signal to the CFG, that indicates parity error. The mem_fail is an output signal to the interrupt block of the CFG that indicates memory failure.

The CFAP is further implemented by signals that indicate buffer status and the validity of the cell address. The adm_buffer_full signal is an output signal that sends an indication to the ADM that the buffer is full. The buffer_full indication to the ADM should be sent at least 22 cells before all of the buffers are used up. This is because the ADM state has to ensure that at most 1 cell is consumed by the ENQ after the buffer_full condition has been asserted by the CFAP. Thus, at most 22 cells (1 cell per port, plus one extra cell for turnaround) will be consumed by the ENQ after buffer_full has been asserted. The IP0_buffer_full signal is an output signal to the ingress module IP0 that indicates that the buffer is full. Similarly, the IP1_buffer_full is an output signal to the ingress module IP1 that the buffer is full. The buffer_full indications to the ADM, IP0 and IP1 are logical identical but are transmitted separately to ensure there are no drive strength problems.

The CFAP is further implemented by interface signals, input to the CFAP, that indicate that cells are being sent to the engress modules, and pointers of cells that are sent to the engress ports which can now be re-used. The cell_release_vld_0 signal indicates to the CFAP that a cell is being sent to the EP0 module. The cell_release_ptr_0 [13:0] signal indicates to the CFAP the pointer of the cell being sent to the EP0, which as stated above, can be reused. Similarly, the cell_release_vld_1 input signal indicates that a cell is being sent to the EP1. The cell_release_ptr_1[13:0] indicates to the CFAP the pointer of the cell being sent to the EP1 module which can be reused now.

Because there are two cell pointers 0 and 1 there input signals to the CFAP. Thus, the CFAP inputs signals indicating the values of the cell pointers and whether the cell pointers are to be recycled. The celladdr_recycle_0 signal indicates that the cell pointer 0 is to be recycled. The celladdr_ptr_0[13:0] signal indicates the value of cell pointer 0. Likewise, the celladdr_recycle_1 signal indicates that the cell pointer 1 is to be recycled. The celladdr_ptr_1[13:0] indicates the value of the cell pointer 1.

Further, there are output signals that indicate the values for the cell pointer for ingress modules and whether the cell pointers are valid. The celladdr_vld_0, and celladdr_vld_1 indicate that the cell pointers for IP0 and IP1 respectively, are valid. The celladdr_ptr_0[13:0] and the celladdr_ptr_1 [13:0] indicate the values for the cell pointers of IP0 and IP1 respectively. The vld signals indicate that the cell_ptr is valid only if the corresponding vld signal is 1. Further, the CFAP guarantees a new cell every clock cycle unless the vld signal is 0.

The CFAP according to this exemplary embodiment includes several registers. The CFAPCONFIG register may consist of two fields; CFAPPOOLSIZE and CFAPINIT. The CFAPPOOLSIZE field indicates the number of cell pointers of the CBP memory. This field should not be set higher than the reset value and should be set to a minimum of 128. The CFAPINIT field initializes the CFAP memory and should be initially set to 1 after rearranging the pointers.

The CFAPFULLTHRESHOLD register includes the CFAPFULLSETPOINT and CFAPFULLRESETPOINT fields. The CFAPFULLSETPOINT field defines the threshold of the CFAP full condition. The CFAP is full when the CFAP Read Pointer is above the limit indicated in this field. The CFAPFULLRESETPOINT field defines the threshold of existing CFAP full condition. The CFAP is not full when the CFAP Read Pointer is below this limit.

The CFAPREADPOINTER register includes two fields; CFAPREADPOINTER and CFAPFULLSTATUS, and can be thought of as the current depth, or number of entries, of the CFAP stack. The CFAPREADPOINTER field indicates the current number of cells that are outstanding in the CBP. The CFAPFULLSTATUS field indicates the current CBF Full status.

The CFAPPARITYERRORPTR register includes one field. This field indicates the memory address at which the most recent CFAP ECC error occurred. If more than one parity/ECC errors occur, only the most recent failure address is reported.

FIG. 9 illustrates a flow diagram in accordance with certain embodiments of the invention. After the process is started (START) 910 the memory locations of the memory address pool are obtained and initialized 920. Next, the locations of the cell-free address pool are initialized 930. The MMU will perform a read and/or write to an available memory location 940. Next, the process will determine the number of locations accepted and the number of cells returned to the CBP 950, and determine the next available memory locations 960. If the difference between the number of locations accepted and the number of locations returned is “1”, the cache memory is accessed 970. Then the CFAP will indicate the next available memory locations 980.

One of average skill in the art will also recognize that the functional building blocks, and other illustrative blocks, modules and components herein, can be implemented as illustrated or by discrete components, application specific integrated circuits, processors executing appropriate software and the like or any combination thereof. For example, a network device includes, but is not limited to, a switch, router, bridge or other network devices known in the art.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for managing memory in a network device, said method comprising the steps of:
providing a memory including a plurality of memory locations configured to store data therein;
providing a memory address pool having a plurality of available memory addresses; and
providing a cell free address pool (CFAP), including a memory address pointer, wherein the memory address pointer indicates a next available memory address in the memory address pool;
reading at least one next available memory address from the memory address pool;
writing at least one released memory addresses into the memory address pool; and
adjusting a position of the memory address pointer upon a read or a write operation from the memory address pool.

2. A method for managing memory in a network device as recited in claim 1, wherein the steps of reading available memory addresses and writing released memory addresses are initiated in one clock cycle.

3. A method for managing memory in a network device as recited in claim 1, further comprising providing a cache memory, wherein the cache memory stores excess memory addresses for the CFAP, and wherein at least one are initially loaded into the cache memory.

4. A method of managing memory in a network device as recited in claim 3, further comprising:
determining a number of memory addresses allocated by the memory pool;
determining a number of memory address returned to the memory pool; and
determining a difference between the number of memory address accepted from the memory pool and the number of memory addresses returned to the memory pool,
wherein if the difference is one, the cache memory operates to perform one of either store one of the memory addresses or provide an additional memory address.

5. A method for managing memory in a network device as recited in claim 1, wherein the transferring step operates without incrementing or decrementing a next available memory address pointer associated with the memory.

6. A method for managing memory in a network device as recited in claim 5, wherein the method further comprises passing the address released without incrementing or decrementing the address pointer.

7. An apparatus for managing memory in a network device, said apparatus comprising:
a memory address pool having a plurality of memory addresses;
a cell free address pool (CFAP), wherein the CFAP includes an associated identifier for each memory address in the memory address pool;
a memory controller in connection with said memory address pool,
wherein said memory controller manages an address pointer in the CFAP, for indicating a next available memory address in said memory address pool and is configured to pass the released memory address in place of the available memory address upon a request for the available memory address.

8. An apparatus for managing memory in a network device as recited in claim 7, wherein said memory address pool further comprises a cell free address pool.

9. An apparatus for managing memory in a network device as recited in claim 8, further comprising a cache memory.

10. An apparatus for managing memory in a network device as recited in claim 7, wherein said memory controller is further configured to read an available memory address from said memory address pool and to write a released memory addresses to said address pool in one clock cycle.

11. An apparatus for managing memory in a network device as recited in claim 9, wherein said memory controller is further configured to pass the released memory address upon a request for the available memory address in the same clock cycle without adjusting said address pointer.

12. An apparatus for managing memory in a network device, said apparatus comprising:
a memory address pool in connection with a memory;
a cell free address pool (CFAP), wherein the CFAP include an associated identifier for each memory address in the memory address pool; and
a memory controller in connection with said memory and said memory address pool, wherein said memory controller passes a released memory address to a request for an available memory address in place of the available memory address when the request for said available memory address is received during the same clock cycle as said released memory address is released.

13. An apparatus for managing memory in a network device as recited in claim 12, wherein said memory comprises RAM.

14. An apparatus for managing memory in a network device as recited in claim 12, wherein said CFAP comprises a stack configuration.

15. An apparatus for managing memory in a network device as recited in claim 14, further comprising a cache memory for storing and providing memory addresses.

16. An apparatus for managing memory in a network device as recited in claim 12, wherein said memory controller, further comprises a RAM controller.

17. An apparatus for managing memory in a network device, said apparatus comprising:
a memory including a plurality of memory locations configured to store data therein;
a memory address pool having a plurality of available memory addresses;
a cell free address pool (CFAP), wherein the CFAP include an associated identifier for each memory address in the memory address pool;
means for managing a memory address pointer, wherein the memory address pointer indicates a next available memory address in the memory address pool;
means for reading available memory addresses from the memory address pool; and
means for writing released memory addresses into the memory address pool,
wherein said means for reading and said means for writing are configured to pass an available memory address in place of a next available memory address when a request to read an address is received during the same clock cycle as a request to write an address.

18. An apparatus for managing memory in a network device as recited in claim 17, further comprising a cache memory for storing and providing memory addresses.

19. An apparatus for managing memory in a network device as recited in claim 17, wherein the CFAP is a stack configuration.

20. An apparatus for managing memory in a network device as recited in claim 17, wherein the CFAP is a queue configuration.
